(19) United States
(12) Patent Application Publication
(10) Pub. No.: US 2006/0230621 A1
(43) Pub. Date: Oct. 19, 2006

(54) Cutter assembly for hair clipper

(75) Inventor: Yi-Tang Liao, Taichung County (TW)

Correspondence Address: BACON & THOMAS, PLLC, 625 SLATERS LANE, FOURTH FLOOR, ALEXANDRIA, VA, 22314, US

(73) Assignee: JENG SHYUAN PRECISION CO., LTD., TAICHUNG COUNTY (TW)

(21) Appl. No.: 11/392,591

(22) Filed: Mar. 30, 2006

(30) Foreign Application Priority Data
Apr. 15, 2005 (TW) 94205995

(51) Int. Cl. B26B 19/00

(52) U.S. Cl. 30/223

(57) ABSTRACT

A cutter assembly for hair clipper includes a fixed blade set, which has a series of cutters, a mount, and a coupling portion, a movable blade set, which has a series of cutters, a coupling portion slidably coupled to the coupling portion of the fixed blade set to guide movement of the series of cutters of the movable blade set relative to the series of cutters of the fixed blade set, and a bearing portion, and a biasing mechanism, which has a spring holder pivotally mounted on the mount of the fixed blade set and a spring member mounted on the spring holder and stopped against the bearing portion of the movable blade set for biasing the movable blade set relative to the fixed blade set.

### BACKGROUND OF THE INVENTION

1. Field of the Invention

The present invention relates generally to hair clipper and more particularly, to an improved structure of cutter assembly for hair clipper, which is safe and stable in use.

2. Description of the Related Art

A regular hair clipper generally comprises a fixed metal cutter blade and a plastic holder base holding the fixed metal cutter blade. During the operation of the hair clipper to cut hairs, hairs may be jammed in the gap between the fixed metal cutter blade and the plastic holder base.

There is known another design of hair clipper of which the fixed cutter blade has a flat bottom wall pressed on the movable cutter blade by a spring member. This structure of hair clipper has a simple design that is less attractive to consumers.

### SUMMARY OF THE INVENTION

The present invention has been accomplished under the circumstances in view. It is one object of the present invention to provide a cutter assembly for hair clipper, which has the parts thereof steadily coupled together for a smooth action, assuring a high safety in operation. It is another object of the present invention to provide a cutter assembly for hair clipper, which allows smoothly movement of the movable blade set in a relatively wider range.

To achieve these and other objects of the present invention, the cutter assembly for hair clipper comprises a fixed blade set, a movable blade set, and a biasing mechanism. The fixed blade set comprises a series of cutters, a mount, and a coupling portion disposed between the series of cutters and mount of the fixed blade set. The movable blade set, comprises a series of cutters movable relative to the series of cutters of the fixed blade set, a coupling portion slidably coupled to the coupling portion of the fixed blade set to guide movement of the series of cutters of the movable blade set relative to the series of cutters of the fixed blade set, and a bearing portion. The biasing mechanism is adapted to bias the movable blade set relative to the fixed blade set, comprising a spring holder pivotally mounted on the mount of the fixed blade set, and a spring member mounted on the spring holder and stopped against the bearing portion of the movable blade set.

### BRIEF DESCRIPTION OF THE DRAWINGS

FIG. 1 is an exploded view of a cutter assembly for hair clipper of a preferable embodiment according to the present invention.

FIG. 2 is another exploded view of the cutter assembly according to the present invention when viewed from another direction.

FIG. 3 is a top assembly view of the cutter assembly according to the present invention.

FIG. 4 is a side assembly view of the cutter assembly according to the present invention.

FIG. 5 is a sectional view taken along line 5-5 of FIG. 3.

FIG. 6 corresponds to FIG. 5, showing the cutter assembly in action.

FIG. 7 is an exploded view of an alternate form of the cutter assembly according to the present invention.

### DETAILED DESCRIPTION OF THE INVENTION

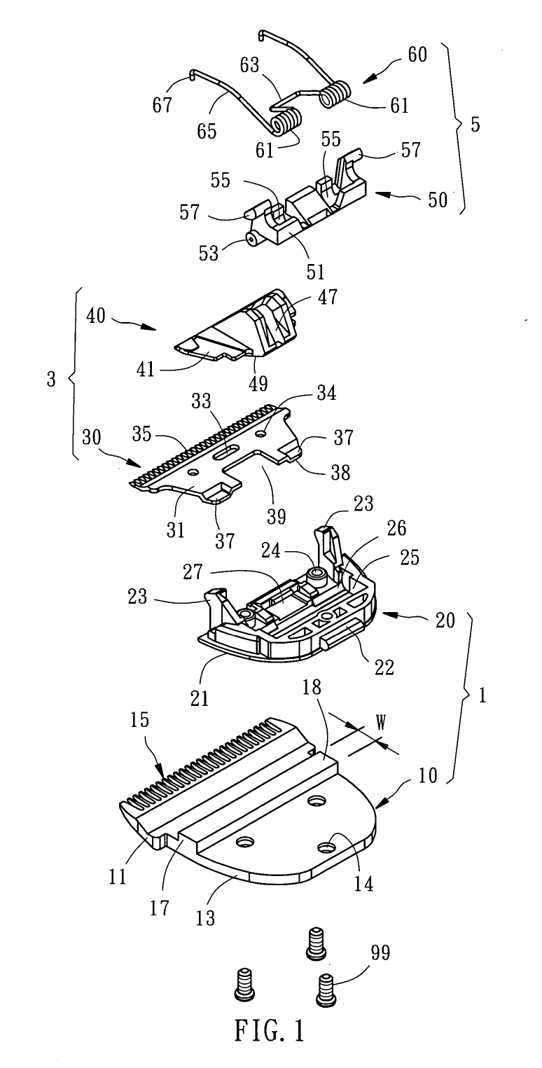

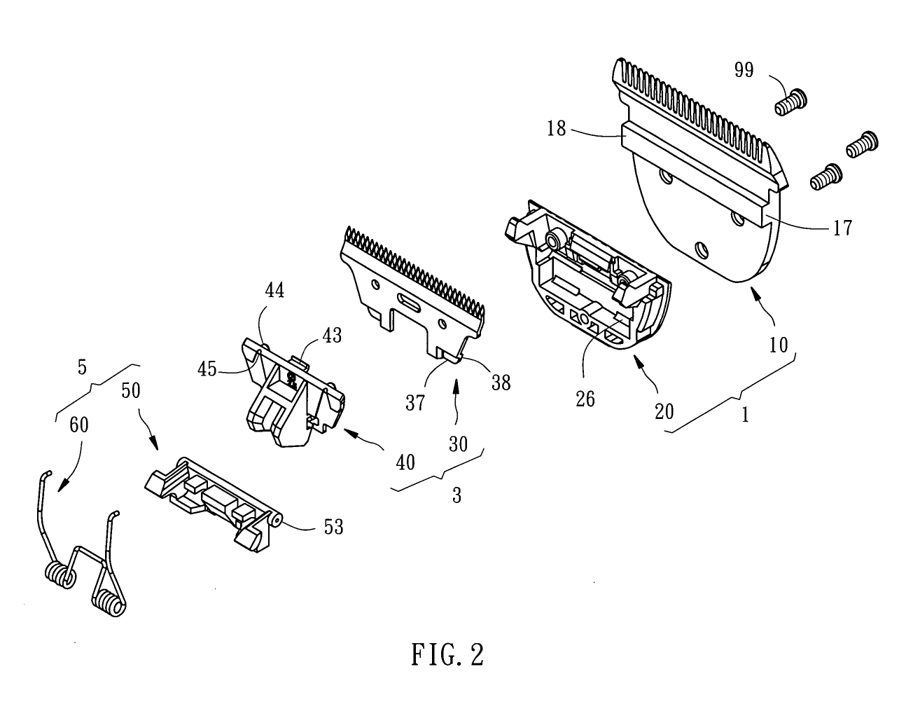

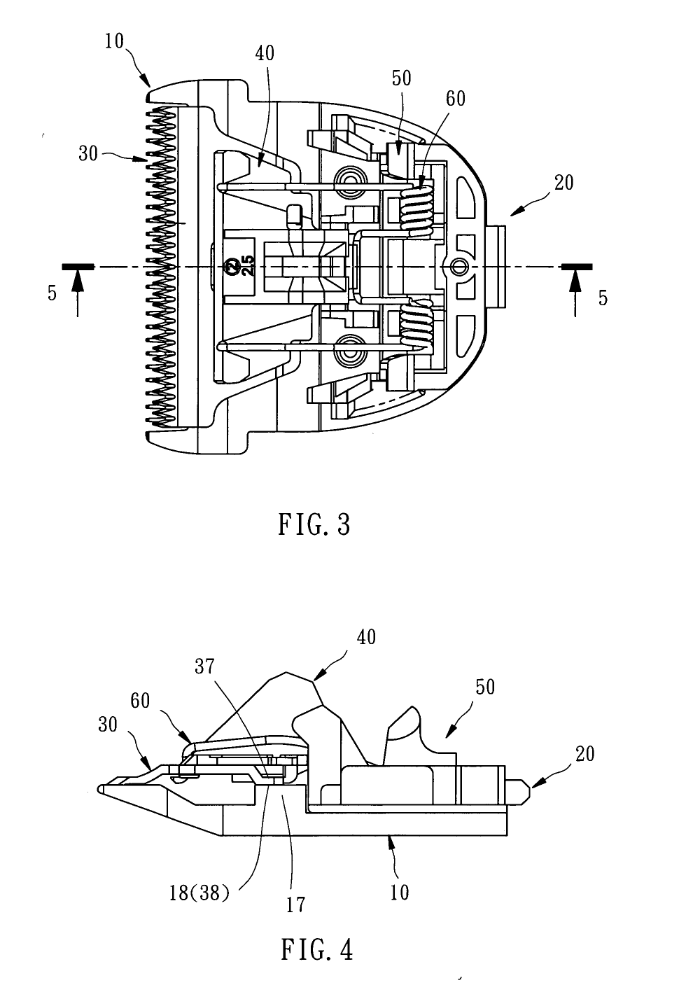

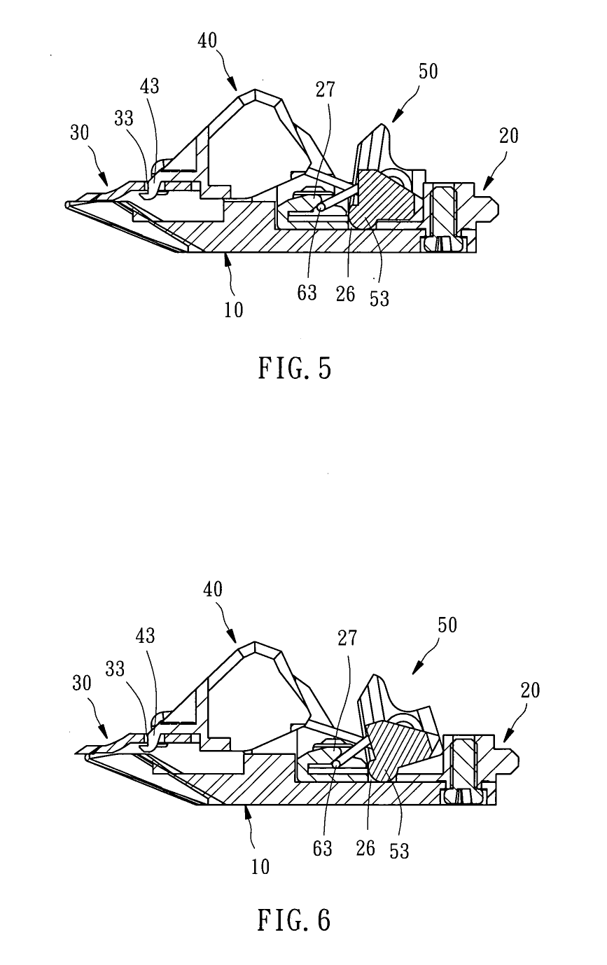

Referring to FIGS. 1˜5, a cutter assembly for hair clipper in accordance with the present invention is shown comprised of a fixed blade set 1, a movable blade set 3, and a biasing mechanism 5. The fixed blade 1 is comprised of a fixed blade 10 and a fixed blade holder 20. The movable blade set 2 is comprised of a movable blade 30, and a movable blade holder 40. The biasing mechanism 5 is comprised of a spring holder 50 and a torsional spring 60.

The fixed blade 10 has a base 11, a flat mounting portion 13, a plurality of mounting holes 14 cut through top and bottom sides of the flat mounting portion 13, a series of cutters 15 arranged at one side of the base 11 opposite to the flat mounting portion 13, and an upwardly protruding coupling portion 17 connected between the base 11 and the mounting portion 13. The coupling portion 17 has a top sliding face 18. The top sliding face extends in direction perpendicular to the extending directions of the cutters 15, configuring a width W.

The fixed blade holder 20 has a holder base 21, a handle 22 at one side, namely, the back side of the holder base 21, two upright supports 23 vertically upwardly extending from the top wall of the holder base 21 at two sides, a plurality of mounting through holes 24 respectively cut through the top and bottom sides of the holder base 21 and respectively fastened to the mounting holes 14 of the mounting portion 13 of the fixed blade 10 with respective screws 99, a mount 25 formed on the holder base 21 for the mounting of the spring holder 50 of the biasing mechanism 5, two pivot holes 26 symmetrically arranged at two sides above the holder base 21 behind the upright supports 23, and a springy retaining portion 27 disposed at the top side of the holder base 21 on the middle.

The movable blade 30 has a base 31 configuring a mounting portion 33, a plurality of mounting holes 34 cut through top and bottom sides of base 31, a series of cutters 35 arranged at one side, namely, the front side of the base 31, two coupling portions 37 bilaterally formed on the other side, namely, the rear side of the base 31, and an opening 39 defined between the two coupling portions 37. The coupling portions 37 each have a sliding face 38.

The movable blade holder 40 has a holder base 41, a hook 43 protruded from the holder base 41, two posts 44 respectively extended from the holder base 41, two bearing portions 45 respectively axially formed on the posts 41, a driven portion 47, and an opening 49.

The spring holder 50 has a holder base 51, two pivots 53 disposed at two sides and respectively pivotally coupled to the pivot holes 26 of the fixed blade holder 20, two receiving portions 55 for receiving the torsional spring 60, and two stop rods 57 respectively spaced above the pivots 53.

The torsional spring 60 has two coiled portions 61, a positioning portion 63 connected between the inner ends of the coiled portions 61, and two connecting arms 65 respectively extending from the outer ends of the coiled portions 61 and terminating in a respective mounting tip 67.

The fixed blade 10 is made in integrity. The bottom wall of the fixed blade 10 between the cutters 15 and the flat mounting portion 13 is a whole flat wall that prevents jamming of hairs in between the fixed blade 10 and the movable blade 30. The fixed blade holder 20 is fastened to the rear part of the upper side of the fixed blade 10. This mounting arrangement has a high strength and stability superior than conventional designs.

Further, the top sliding face 18 of the coupling portion 17 of the fixed blade 10 matches the sliding face 38 of the coupling portion 37 of the movable blade 30 perfectly, assuring smooth movement of the movable blade 30 relative to the fixed blade 10.

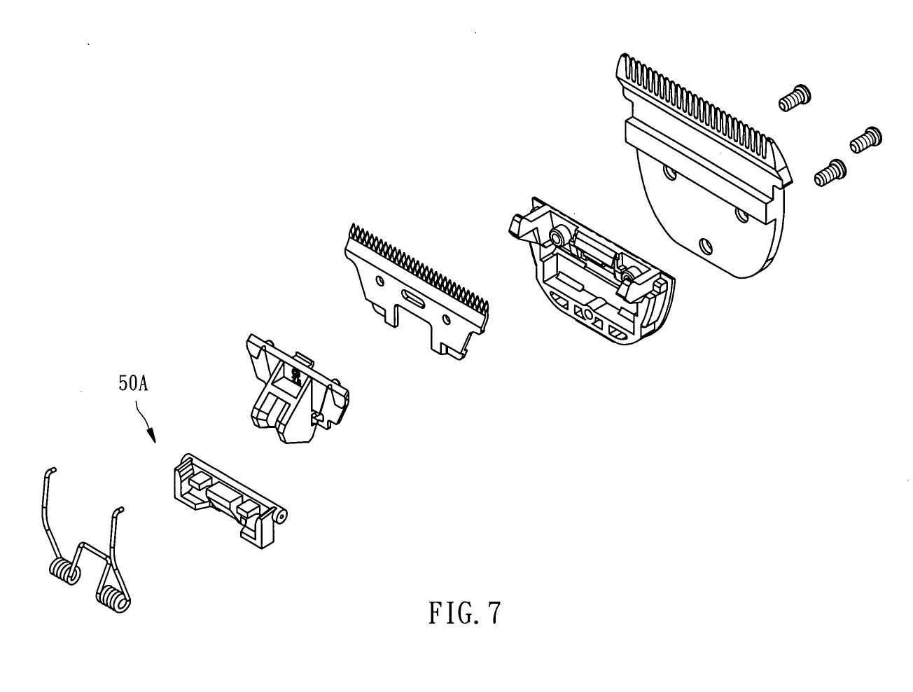

Further, as shown in FIG. 6, when the spring holder 50 is driven by a lift control mechanism (not shown), the top sliding face 18 of the coupling portion 17 of the fixed blade 10 provides a wide area of the width W for allowing axial movement of the movable blade 30, and therefore the movable blade set 3 can accurately moved up and down to the fixed blade set 1 relatively.

FIG. 7 shows an alternate form of the present invention. According to this embodiment, the spring holder 50A does not have the aforesaid stop rods 57, i.e., the spring holder 50A is not biasable. This second embodiment has the advantage of simple structure while achieving the same effect as the aforesaid first embodiment.

As indicated above, the invention provides a cutter assembly for hair clipper that has the following characteristics:

1. The parts of the cutter assembly for hair clipper are steadily coupled together for a smooth action, assuring a high safety of the fixed blade set.

2. The cutter assembly for hair clipper allows smoothly movement of the movable blade set in a relatively wider range.

What is claimed is:

1. A cutter assembly for hair clipper comprising:
a fixed blade set, said fixed blade set comprising a series of cutters, a mount, and a coupling portion disposed between the series of cutters and mount of said fixed blade set;
a movable blade set, said movable blade set comprising a series of cutters movable relative to the series of cutters of said fixed blade set, a coupling portion slidably coupled to the coupling portion of said fixed blade set to guide movement of the series of cutters of said movable blade set relative to the series of cutters of said fixed blade set, and a bearing portion; and
a biasing mechanism adapted to bias said movable blade set relative to said fixed blade set, said biasing mechanism comprising a spring holder pivotally mounted on said mount of said fixed blade set, and a spring member mounted on said spring holder and stopped against the bearing portion of said movable blade set.

2. The cutter assembly as claimed in claim 1, wherein said fixed blade set further comprises a fixed blade holder, and a fixed blade, said fixed blade having a part that forms the series of cutters of said fixed blade set and a mounting portion fastened to said fixed blade holder.

3. The cutter assembly as claimed in claim 2, wherein the mount of said fixed blade set is provided at said fixed blade holder.

4. The cutter assembly as claimed in claim 1, wherein the coupling portion of said fixed blade set protrudes upwards.

5. The cutter assembly as claimed in claim 1, wherein said spring member is a torsional spring.

6. A cutter assembly for hair clipper comprising:
a fixed blade set, said fixed blade set comprising a series of cutters, a coupling portion formed integral with the series of cutters of said fixed blade set, and a mount;
a movable blade set, said movable blade set comprising a series of cutters movable relative to the series of cutters of said fixed blade, a coupling portion slidably coupled to the coupling portion of said fixed blade set to guide movement of the series of cutters of said movable blade set relative to the series of cutters of said fixed blade set, and a bearing portion; and
a biasing mechanism mounted on said mount of said fixed blade set and adapted to bias said movable blade set relative to said fixed blade set, said biasing mechanism comprising a torsional spring, said torsional spring having a coiled portion and being stopped against the bearing portion of said movable blade set.

7. The cutter assembly as claimed in claim 6, wherein said biasing mechanism further comprises a spring holder pivotally mounted on said mount of said fixed blade set for holding said torsional spring.

8. The cutter assembly as claimed in claim 6, wherein said fixed blade set further comprises a fixed blade holder, and a fixed blade, said fixed blade having a part that forms the series of cutters of said fixed blade set and a mounting portion fastened to said fixed blade holder.

9. The cutter assembly as claimed in claim 8, wherein the mount of said fixed blade set is provided at said fixed blade holder.

10. The cutter assembly as claimed in claim 6, wherein the coupling portion of said fixed blade set protrudes upwards.
